(19) United States
(12) Patent Application Publication
(10) Pub. No.: US 2009/0132209 A1
(43) Pub. Date: May 21, 2009

(54) METHOD FOR ANALYZING DAMAGE TO A PHYSICAL PLANT

(75) Inventor: Troy Coleman, Bowling Green, KY (US)

Correspondence Address: AT&T Legal Department - WK;Attn: Patent Docketing, Room 2A-207, One AT&T Way, Bedminster, NJ, 07921, US

(73) Assignee: AT&T Delaware Intellectual Property, Inc., Wilmington, DE (US)

(21) Appl. No.: 11/954,908

(22) Filed: Dec. 12, 2007

(51) Int. Cl. G06F 17/11; G06F 17/50

(52) U.S. Cl. 703/1; 703/2

(57) ABSTRACT

Analyzing data relating to physical-plant damage within a geographical region involves mapping data points to depict the density of incidents producing the damage. Mapping the data points produces a density surface corresponding to incidents of damage occurring within the particular geographical region under consideration. That density surface is preferably depicted in conjunction with a map or other visual representation of the geographical region, providing a visual representation showing the location and frequency of damage to the physical plant within that geographical region. The mapping of data points may be updated from time to time, thereby providing updated mapping of damaged density surface against which efforts to reduce damage over time may be compared with the results of such efforts.

### FIELD OF THE INVENTION

This application relates in general to analyzing data with respect to events occurring within a geographic region, and relates in particular to a method for analyzing damage events occurring to a physical plant including elements within a certain geographical region.

### BACKGROUND OF THE INVENTION

Anyone having a significant investment in physical plant will seek to minimize damage to elements of that physical plant. (The term “physical plant”, as used herein, refers to the infrastructure that supports a particular facility or system.) The problem of mitigating or eliminating damage to physical plant is particularly compelling in fields such as telecommunications, although not so limited, because significant portions of the physical plant are often located underground and are thus not visible to a casual inspection above ground. For example, wire or fiber-optic cables are typically located underground and are subject to damage by activities such as trenching or horizontal drilling to repair or install additional infrastructure. Because even a single such cable is capable of carrying multiple signal paths, e.g., voice or data traffic, a damaged cable can adversely affect the performance of the carrier utilizing the cable. For that reason, damaged cables or other underground infrastructure must be repaired or replaced, an expensive and time-consuming endeavor. For those reasons, operators of outside physical plant seek to prevent damage to that plant and should focus their damage-prevention efforts into areas of the physical plant that are most likely to undergo the greatest extent of damage, based on past history.

### SUMMARY OF THE INVENTION

Embodiments provide methods for analyzing data relating to damage by mapping data points in such a way as to depict the density of incidents producing the damage. Mapping the data points according to the disclosed embodiments transforms the data points into a density surface corresponding to incidents of damage occurring within a particular geographical region under consideration. That density surface is preferably depicted in conjunction with a map or other visual representation of the geographical region. The resulting map provides a visual representation showing the location and frequency of damage to the physical plant within that geographical region, from which an operator of the physical plant may direct efforts to minimize future incidents of damage. The mapping of data points may be updated from time to time, thereby providing updated mapping of damaged density surface against which efforts to reduce damage over time may be compared with the results of such efforts.

Other methods, systems, or computer program products according to embodiments will be or become apparent to one with skill in the art upon review of the following drawings and detailed description. It is intended that all such additional systems, methods, and computer program products be included within this description., be within the scope of the present invention, and be protected the accompanying claims.

### BRIEF DESCRIPTION OF THE DRAWINGS

FIG. 1 is a block diagram representing elements of a method according to disclosed embodiments.

FIG. 2 depicts a map prepared according to the disclosed embodiments and representing density of damage points to a particular physical plant within a certain geographical region.

### DETAILED DESCRIPTION

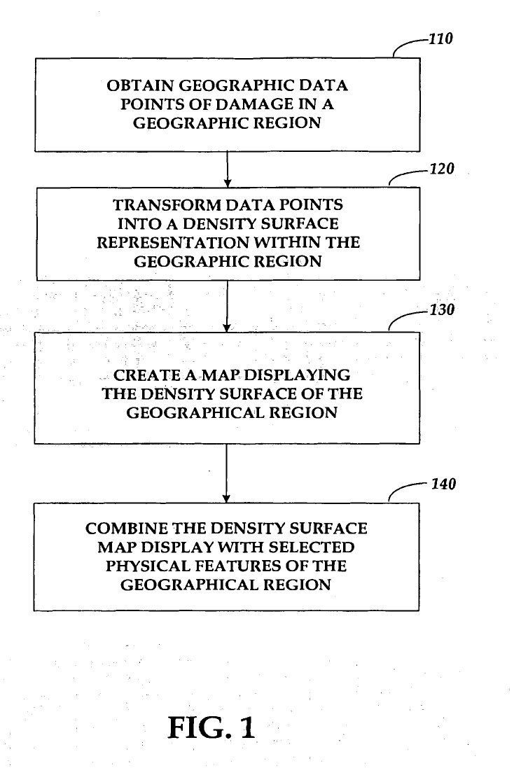

Analyzing physical-plant damage according to the disclosed embodiments typically commences by gathering all available location data where damage has occurred over a time interval of interest, within a particular geographic region under consideration. This aspect is shown at 110 in FIG. 1. Because the geographic data will be entered into a geographic information system (GIS) to visually convey information, e.g., in a map format, the damage location data must be made available or converted into point data within the GIS for each damage location. Examples of point data information are known to those skilled in the art, one example being longitude-latitude information. Data entry on a GIS may also create a data point for each damage location via a “push pin” map, where each data point represents one particular damage incident spatially located relative to other features such as streets, rivers, or the like provided by one or more map layers available in an appropriate GIS.

One example of a GIS for performing embodiments of the present invention is the ArcInfo system available from ESRI, Redlands, Calif. The foregoing exemplary GIS is disclosed without limitation, and those skilled in the art will understand that embodiments of the present invention may utilize any suitable alternative GIS.

After the damage location data for each instance of damage are obtained and entered as data points, those data points are transformed at 120 into a density surface using the density analysis capability of the GIS. Using the GIS software, a visual display is prepared at 130, preferably in the form of a map displaying the density surface of the data points representing damage locations throughout the geographical region under consideration. As denoted at 140, the map or similar visual display preferably combines the density surface of damage data overlaid or otherwise combined with physical features such as roads and administrative boundaries such as cities or counties, wire centers between which the underground or buried physical plant extends, service areas, or other relevant physical or functional features within the geographical region.

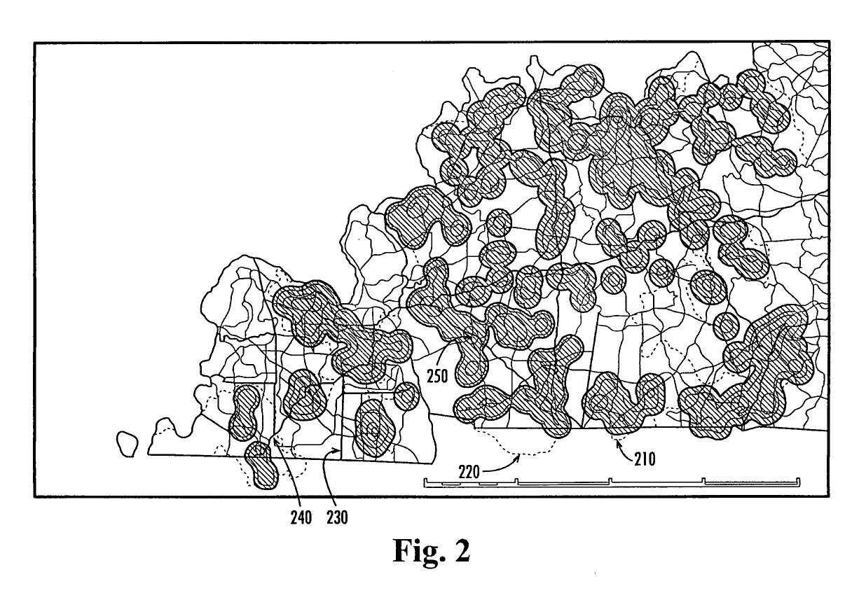

FIG. 2 is an example of visual mapping obtained by analyzing geographical damage data according to embodiments. In that figure, the density surface representations indicated collectively as 210 appear as overlays onto a geopolitical map 220 of a particular geographic region. The geopolitical map 220 may include political boundaries such as the county designators 230 as well as cities or towns identified within the respective counties, and preferably also includes real-world features such as roads or highways 240 extending through the geographical region. The damage clusters 210 are preferably generated with visual attributes, such as color and/or shading, keyed to a predetermined metric such as, for example, incidents of damage per square mile. It should be understood, of course, that other visual indicators and damage-related metrics may be included or substituted to provide the user with a visual representation of damage occurring to the physical plant within the geographical area being mapped.

It will be apparent that the map shown in FIG. 2 provides an immediate visual display showing where damage has occurred to the physical plant in the geographic area represented by that map. Persons responsible for that physical plant may thus more readily analyze the mapped damage-related information and can allocate resources to those areas showing the greatest concentration of damage according to the displayed metric. For example, it will be noted that the visual damage areas 210 shown in FIG. 2 tend to cluster at certain population areas and along certain roads extending between those population areas. Those depictions of damage shown in FIG. 2 may be explained by understanding that buried or underground communications cables typically are installed along the right-of-way for existing roads or streets, and extend between towns or other locations including wire centers or other hubs at which the cables terminate. The damage analysis represented in FIG. 2 also shows that damage tends to cluster along certain roads, e.g., as indicated at 250, while other roads and areas are relatively damage-free. This depiction thus provides an immediate and understandable indication of where best to concentrate efforts for reducing or alleviating future occurrences of such damage.

The depiction shown in FIG. 2 represents a snapshot in time, based on data points accumulated over a known period of time. Accordingly, damage-related data occurring in later time periods may advantageously be mapped to provide a visual comparison with the past or present as represented in FIG. 2. The two or more maps may then be compared to see whether damage to the physical plant has changed overall or in only some portions of the geographical area under consideration.

It should also be understood that the foregoing relates only to embodiments of the present invention and that numerous changes and modifications made therein may be made without departing from the spirit and scope of the invention as set forth in the following claims.

1. A computer-implemented method for analyzing damage to a physical plant, comprising:
obtaining data points corresponding to geographic locations where damage to the physical plant is determined to have occurred within a predetermined geographical region;
transforming the data points into a density surface correlating to the occurrences of damage in the predetermined geographical region; and
creating a map that displays the density surface so as to provide a visual representation of the spatial locations of the damage within the predetermined geographical region.

2. The method of claim 1, wherein creating the map further comprises:
depicting physical features of the predetermined geographical region represented in the map; and
overlaying the density surface onto the depicted physical features so as to display the density surface of the damage in geographical relation to the depicted physical features.

3. The method of claim 2, wherein the depicted features include physical features of the predetermined geographical region and administrative boundaries within the predetermined geographic region.

4. The method of claim 3, wherein the physical plant comprises a telecommunication system including elements located underground.

5. The method of claim 4, wherein the telecommunication system include at least one wire center operatively interconnected with the elements located underground.

6. The method of claim 2, wherein the physical plant comprises a telecommunication system including elements located underground, and the data points correspond to locations of damage occurring to the underground elements by a physical incursion of at least one underground element.

7. The method of claim 3, wherein creating the map comprises creating a first map using first data points representing a first point in time, and further comprising:
obtaining second data points at a later time for locations in the predetermined geographic region where subsequent damage to the underground elements is determined to have occurred between the first time and the later time;
transforming the second data points into a second density surface corresponding to the predetermined geographical region;
creating a second map that displays the second density surface so as to provide a visual representation of the spatial locations of the subsequent damage within the predetermined geographical region; and
comparing the visual representations of the second map with the visual representations of the first map to evaluate efforts to reduce damage to the physical plant.

8. The method of claim 1, wherein the physical plant includes circuit elements located underground, and wherein the data points include physical damage to at least one underground circuit element.

9. The method of claim 1, wherein the physical plant includes at least one wire center, and at least one circuit element located at least in part underground and terminating at the wire center.

10. A computer-implemented method for analyzing damage to a physical plant, comprising:
obtaining geographical data representing locations where underground damage to the physical plant has occurred within a predetermined geographical region;
mapping the geographical data into a graphic information system; and
creating a density surface based on the geographical data to produce a visual representation of the locations where the damage occurred within the predetermined geographical region.
